(19) United States
(12) Patent Application Publication
(10) Pub. No.: US 2025/0210847 A1
(43) Pub. Date: Jun. 26, 2025

(54) LOW WIND LOAD ANTENNAS

(71) Applicant: Outdoor Wireless Networks LLC, Claremont, NC (US)

(72) Inventors: Maosheng Liu, Suzhou (CN); Bingyang Li, Suzhou (CN); Joy Huang, Plano, TX (US); Puliang Tang, Suzhou (CN)

(21) Appl. No.: 18/976,478

(22) Filed: Dec. 11, 2024

(30) Foreign Application Priority Data
Dec. 21, 2023 (CN) 202311775585.X

(51) Int. Cl. H01Q 1/00; H01Q 1/42

(52) U.S. Cl. CPC H01Q 1/005; H01Q 1/42

(57) ABSTRACT

The present disclosure is directed to a reduced wind load antenna. The antenna includes a radome having front, rear, and side surfaces, upper and lower end caps attached to upper and lower ends of the radome to define an internal cavity, radiating elements positioned within the internal cavity and configured to transmit and receive radio frequency (RF) signals, and at least two airflow separation delaying features, each airflow separation delaying feature coupled to and extending outwardly from a corner of the rear surface of the radome, whereby the at least two airflow separation delaying features reduce the wind load applied normal to the front surface of the antenna and/or the wind load applied normal to the rear surface of the antenna. Other reduced wind load antenna assemblies are described herein.

### RELATED APPLICATION(S)

The present application claims priority to and the benefit of Chinese Patent Application Serial No. 202311775585.X, filed Dec. 21, 2023, the disclosures of which are hereby incorporated herein in full.

### FIELD OF THE INVENTION

The present invention relates generally to antennas, and more particularly to antennas mounted on an antenna tower, monopole, building or other structure that may be subject to wind loads.

### BACKGROUND

With increased demand for more wireless communication, the number of radio and antenna units that a tower traditionally supports has increased and is expected to continue to increase. New towers will need to be designed to support greater numbers of antenna and radio units, while existing towers are retrofitted to support more units, and effort is made to fully utilize space available on the towers.

In addition, antennas are becoming larger in order to handle more wireless traffic. One parameter that influences antenna design is Effective Projected Area (EPA), which is determined by calculations defined by TIA/ANSI-222-H. EPA is intended to predict the effect of wind loading on an antenna and its mounting structure to enable designers to create a safe design. The configuration of the antenna itself can impact the calculations. As such, minimizing an antenna's contribution to EPA can be desirable. See, e.g., U.S. Pat. No. 11,936,092, issued Mar. 19, 2024, the disclosures of which are incorporated herein by reference in their entirety.

### SUMMARY

As a first aspect, embodiments of the invention are directed to a reduced wind load antenna. The antenna includes a radome having front, rear, and side surfaces, upper and lower end caps attached to upper and lower ends of the radome to define an internal cavity, radiating elements positioned within the internal cavity and configured to transmit and receive radio frequency (RF) signals, and at least two airflow separation delaying features, each airflow separation delaying feature coupled to and extending outwardly from a corner of the rear surface of the radome, whereby the at least two airflow separation delaying features reduce the wind load applied normal to the front surface of the antenna and/or the wind load applied normal to the rear surface of the antenna.

As a second aspect, embodiments of the invention are directed to a reduced wind load antenna. The antenna includes a radome having front, rear, and side surfaces. The radome has a cavity formed between the front surface and at least one of the side surfaces. The antenna further includes at least one wind load reduction insert configured to fit within the cavity of the radome. The at least one wind load reduction insert has a main body including a plurality of recesses formed therein and a plurality of sharp edges residing between each recess.

As a third aspect, embodiments of the invention are directed to a reduced wind load antenna. The antenna includes a radome having front, rear, and side surfaces. The radome has a cavity formed between the front surface and at least one of the side surfaces. The antenna further includes at least one wind load reduction insert configured to fit within the cavity in the radome. The at least one wind load reduction insert has a main body including one or more pairs of protruding ribs extending outwardly from the main body, each rib being spaced apart from each other and extending along a width of the main body at an angle.

It is noted that aspects of the invention described with respect to one embodiment, may be incorporated in a different embodiment although not specifically described relative thereto. That is, all embodiments and/or features of any embodiment can be combined in any way and/or combination. Applicant reserves the right to change any originally filed claim and/or file any new claim, accordingly, including the right to be able to amend any originally filed claim to depend from and/or incorporate any feature of any other claim or claims although not originally claimed in that manner. These and other objects and/or aspects of the present invention are explained in detail in the specification set forth below. Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE FIGURES

FIG. 1A is a front perspective view of a known antenna assembly.

FIG. 1B is a top view of another known antenna assembly.

FIG. 2 illustrates the different wind load directions on an antenna.

FIG. 3 is a top view of an antenna assembly according to embodiments of the present invention.

FIG. 4 is a top view and enlarged partial top perspective view of an antenna assembly according to further embodiments of the present invention.

FIGS. 5A-5C are comparisons of velocity contour plots for frontal wind loading of the antennas depicted in FIG. 1B and FIG. 4.

FIGS. 6A-6C are comparisons of velocity contour plots for rear wind loading of the antennas depicted in FIG. 1B and FIG. 4.

FIG. 7A is a partial top sectional view of an antenna assembly according to further embodiments of the present invention.

FIG. 7B is a top view of an antenna assembly according to further embodiments of the present invention.

FIG. 8A and FIG. 8B are rear perspective views of antenna assemblies according to further embodiments of the present invention.

FIG. 9A is a partial side view of an airflow separation delaying feature that may be incorporated into the antennas of FIGS. 8A and 8B.

FIG. 9B is a photograph of an exemplary airflow separation delaying feature shown in FIG. 9A formed via a pultrusion process.

FIG. 9C is a partial side perspective view of the airflow separation delaying feature of FIG. 9A.

FIG. 9D is a photograph of an exemplary airflow separation delaying feature shown in FIG. 9B formed via a pultrusion process.

FIG. 10A is a top perspective view of a radome assembly for an antenna according to further embodiments of the present invention.

FIG. 10B is an enlarged partial view of the radome assembly shown in FIG. 10A.

FIG. 10C is a partial side view of the radome assembly shown in FIG. 10B.

FIG. 11A is a top perspective view of an airflow separation delaying feature according to embodiments of the present invention included the radome assembly of FIGS. 10A-10C.

FIG. 11B is a top view of the airflow separation delaying feature of FIG. 12A.

FIG. 11C is a side view of the airflow separation delaying feature of FIG. 12A.

FIG. 12 is a partial top perspective view of a radome assembly for an antenna according to further embodiments of the present invention.

FIG. 13A is a top perspective view of an airflow separation delaying feature according to embodiments of the present invention included in the radome assembly of FIG. 12.

FIG. 13B is a side view of the airflow separation delaying feature of FIG. 13A.

FIG. 13C is a bottom perspective view of the airflow separation delaying feature of FIG. 13A.

FIG. 14A is a partial top perspective view of a radome assembly according to further embodiments of the present invention.

FIG. 14B is an enlarged partial view of the radome assembly of FIG. 14A.

FIG. 15A is a top perspective view of an airflow separation delaying feature according to embodiments of the present invention included in the radome assembly of FIGS. 14A-14B.

FIG. 15B is a side view of the airflow separation delaying feature of FIG. 15A.

FIG. 15C is another top perspective view of the airflow separation delaying feature of FIG. 15A.

FIG. 15D is a bottom perspective view of the airflow separation delaying feature of FIG. 15A.

FIG. 16A is a partial top perspective view of a radome assembly according to further embodiments of the present invention.

FIG. 16B is a partial side view of the radome assembly of FIG. 16A.

FIG. 17 is a front perspective view of an antenna assembly according to further embodiments of the present invention.

FIG. 18 is a front perspective view of an antenna assembly according to further embodiments of the present invention.

FIG. 19A is a front perspective view of an antenna assembly according to further embodiments of the present invention.

FIG. 19B is an enlarged partial view of the antenna assembly of FIG. 19A.

FIG. 20A is a rear perspective view of an antenna assembly according to further embodiments of the present invention.

FIG. 20B is an enlarged view of an upper bracket of the antenna assembly of FIG. 20A according to embodiments of the present invention.

FIG. 20C is an enlarged view of a lower bracket of the antenna assembly of FIG. 20A according to embodiments of the present invention.

FIG. 21A is a rear perspective view of an antenna assembly according to further embodiments of the present invention.

FIG. 21B is an enlarged view of an upper hood cap for the antenna assembly of FIG. 21A according to embodiments of the present invention.

FIG. 22A is a rear perspective view of an antenna assembly according to further embodiments of the present invention.

FIG. 22B is a partial enlarged view of an airflow separation delaying feature according to embodiments of the present invention included in the antenna assembly of FIG. 22A.

FIG. 23A is a rear perspective view of an antenna assembly according to further embodiments of the present invention.

FIG. 23B is an enlarged partial rear perspective view of the antenna assembly of FIG. 23A.

FIG. 24A is a rear perspective view of an antenna assembly according to further embodiments of the present invention.

FIG. 24B is a rear perspective view of an antenna assembly according to further embodiments of the present invention.

FIG. 25A illustrates a passive intermodulation (PIM) shield for an antenna assembly according to embodiments of the present invention.

FIG. 25B is a top view of the PIM shield of FIG. 25A.

FIG. 25C is a bottom view of an antenna assembly including the PIM shield of FIG. 25A according to embodiments of the present invention.

FIG. 25D is a velocity contour plot for rear wind loading of the antenna assembly of FIG. 25C according to embodiments of the present invention.

FIG. 26 is a schematic depiction of the phenomenon of delayed flow separation experienced by a golf ball.

FIG. 27 is a schematic depiction of the phenomenon of delayed flow separation as experienced by an airfoil.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

The present invention now will be described more fully hereinafter with reference to the accompanying drawings, in which illustrative embodiments of the invention are shown. Like numbers refer to like elements throughout and different embodiments of like elements can be designated using a different number of superscript indicator apostrophes (e.g., 10′, 10″, 10′″).

In the figures, certain layers, components or features may be exaggerated for clarity, and broken lines illustrate optional features or operations unless specified otherwise. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

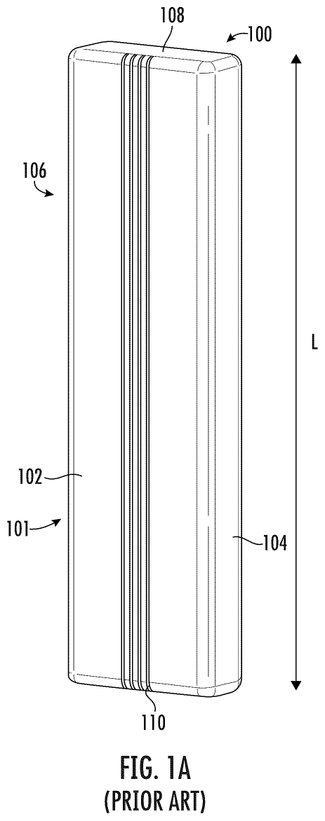

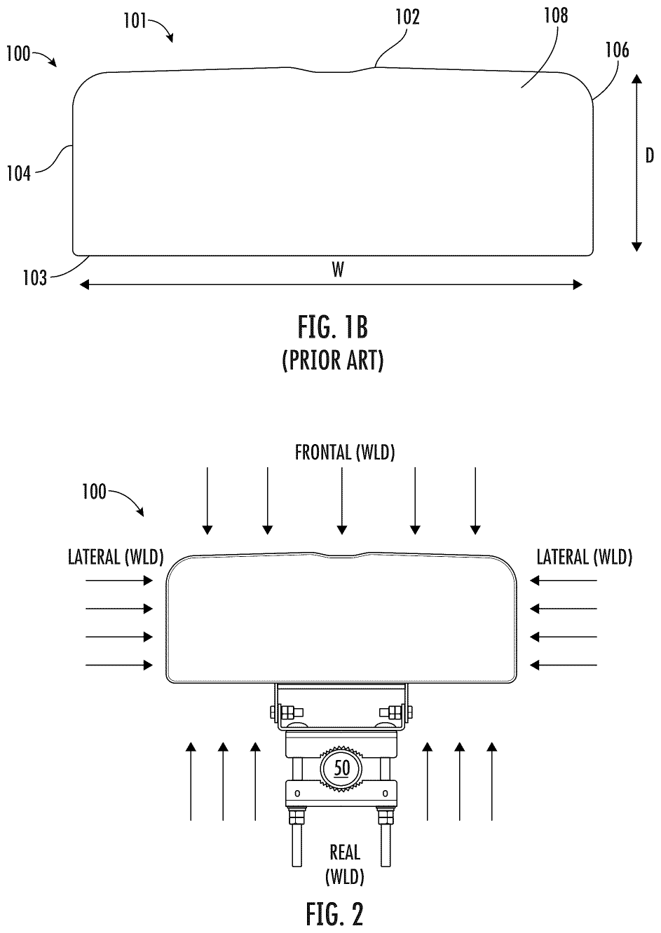

Referring to FIGS. 1A-1B, an existing antenna assembly 100 is illustrated. The antenna 100 is generally elongate and is covered by a radome 101 that includes a front surface 102, a rear surface 103, and side surfaces 104, 106, and further covered by top and bottom end caps 108, 110. In some instances, the radome 101 and end caps 108, 110 may comprise a single monolithic component, whereas in other embodiments the radome 101 and end caps 108, 110 may comprise separate pieces.

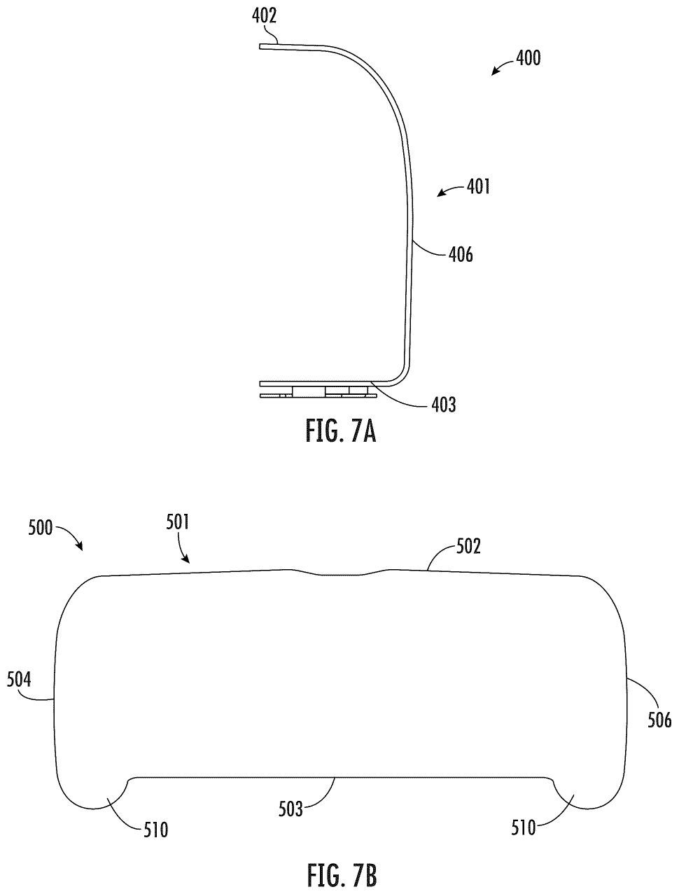

The antenna assembly 100 houses internal antenna components, such as radiating elements, a reflector, phase shifters, diplexers, remote electronic tilt actuators, cables, a controller and the like, that enable the antenna assembly 100 to transmit and receive radio frequency (RF) signals (see, e.g., FIG. 7A). Exemplary antenna components are described in, for example, PCT Publication No. WO 2017/165512A1, the disclosure of which is hereby incorporated herein by reference. The antenna assembly 100 also includes connectors (not shown in FIG. 1A, but visible, for example, in FIG. 27C) that enable the antenna assembly 100 to be connected with one or more radios for the transmission and reception of RF signals, and with other associated telecommunications equipment.

The antenna assembly 100 is typically mounted well above the ground for optimal transmission. As such, the antenna assembly 100 contributes significantly to the overall wind load on a cellular tower. For example, as illustrated in FIG. 2, the antenna assembly 100 may be subjected to high (and in some cases virtually unimpeded) wind loads from any direction (i.e., frontal, rear, and/or lateral wind load directions, WLD). Thus, design elements of the antenna assembly 100, and in particular of the radome 101 and end caps 108, 110, may impact the overall wind load experienced by the antenna assembly 100. Reducing wind load on the antenna assembly 100 is critical and it is important to manage wind load from all different wind attack angles on the antenna assembly 100.

Pursuant to embodiments of the present invention, several radome profiles and add-on features (sometimes referred to herein as “wind load reducing design elements,” “airflow separation delaying features,” or “design element that can reduce wind loading”) are provided that may help to manage wind load on an antenna or antenna assembly. Embodiments of the present invention will now be discussed in greater detail with reference to FIGS. 3-27.

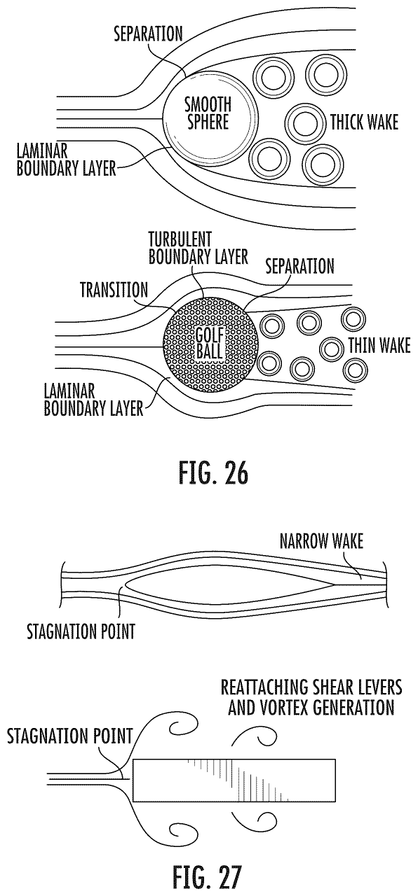

The different design features that will be described herein for reducing wind loading may impact the “flow separation” properties of the antennas. Flow separation occurs when the boundary layer of a fluid stream on an object travels far enough against an adverse pressure gradient that the speed of the boundary layer relative to the object falls almost to zero. The fluid flow becomes detached from the surface of the object, and instead takes the forms of eddies and vortices. In aerodynamics, flow separation can often result in increased drag, particularly pressure drag, which is caused by the pressure differential between the front and rear surfaces of the object as it travels through the air (or as air travels past the object). Common examples of this phenomenon are golf balls (see, e.g., FIG. 26) and airfoils (see, e.g., FIG. 27). Acrodynamic surfaces with delayed flow separation that keep the local flow attached for as long as possible are typically desirable for reduced wind load on an object.

One example of a design element that can reduce wind loading (i.e., an airflow separation delaying feature) according to embodiments of the present invention is provided on the antenna (or antenna assembly) 200 illustrated in FIG. 3. As shown in FIG. 3, each corner (or opposing end) of the rear surface 103 of the radome 101 is modified to have an elongate protuberance 210 extending outwardly therefrom (i.e., rearwardly from the radome 101) (“rear corner”) (see also, e.g., FIGS. 22A-22B). According to embodiments to the present invention, the presence of the protuberances 210 at the rear corners of the radome 101 can reduce the frontal and rear wind load experienced by the antenna 200 compared to a similar “baseline” antenna 100 (i.e., FIGS. 1A-1B) that lacks the protuberances 210 extending outwardly from the corners of the rear surface 103 of the radome 101.

In some embodiments, the distance that the protuberances 210 extend from their underlying surfaces (i.e., from the rear surface 103) may vary. For example, in some embodiments, the protuberances 210 may extend in a range of between about 25 millimeters (mm) and about 35 mm away from the rear surface 103 of the radome 101. In some embodiments, the protuberances 210 may extend longitudinally over only a small fraction of the length L of the radome 101 (e.g., 10 to 25 percent), in which case multiple axially-aligned protuberances 210 may be included (e.g., three equally spaced, axially-aligned protuberances 210 that are 25 percent of the length of the radome 101 may be employed). In other embodiments, the protuberances 210 may extend over a much larger fraction of the length L of the radome 101 (e.g., 50 to 100 percent) (see, e.g., FIG. 22A).

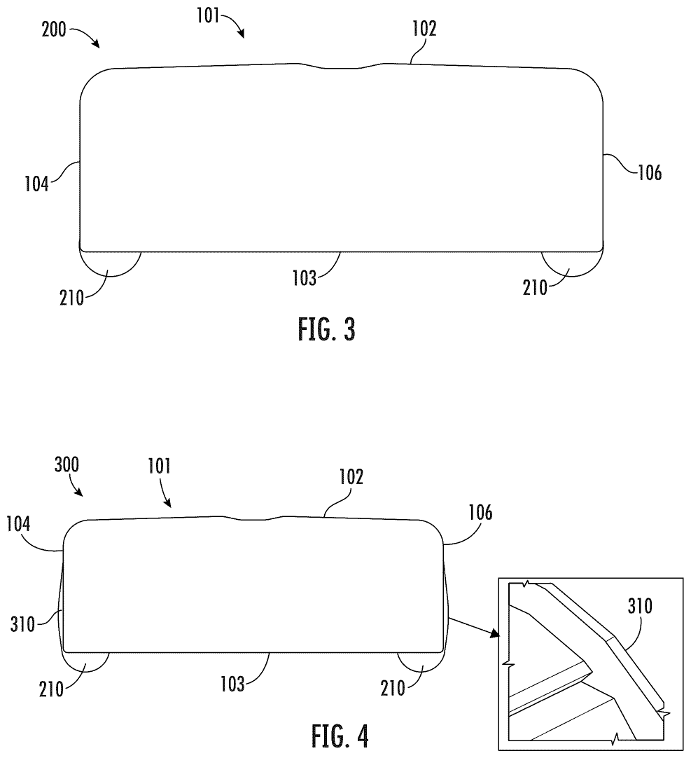

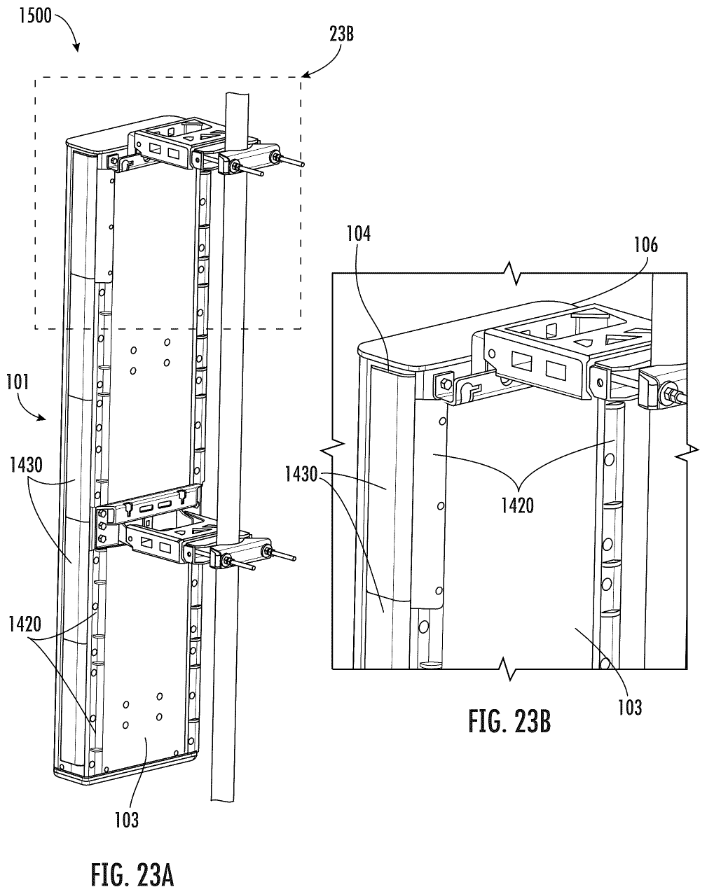

Referring to FIG. 4, another example of a design element that can reduce wind loading according to embodiments of the present invention is provided on antenna (or antenna assembly) 300. The antenna 300 is similar to the antenna 200 shown in FIG. 3 in that the antenna 300 includes protuberances 210 extending outwardly from the corners of the rear surface 103. As shown in FIG. 4, the antenna 300 further includes elongate protuberances 310 extending outwardly from the side surfaces 104, 106 of the radome 101 (see also, e.g., FIGS. 23A-23B).

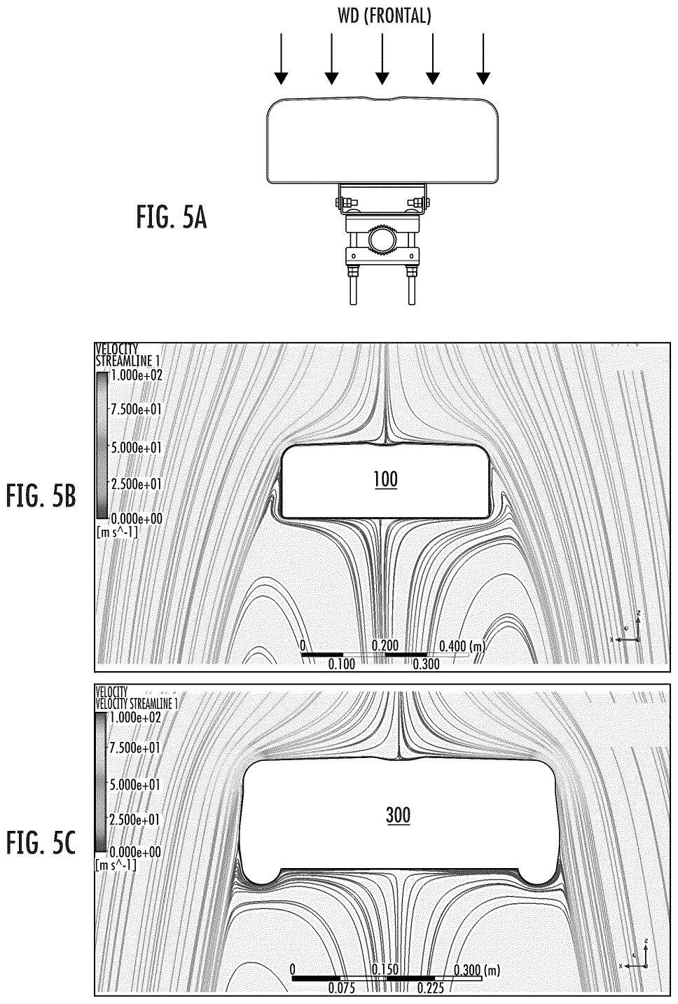

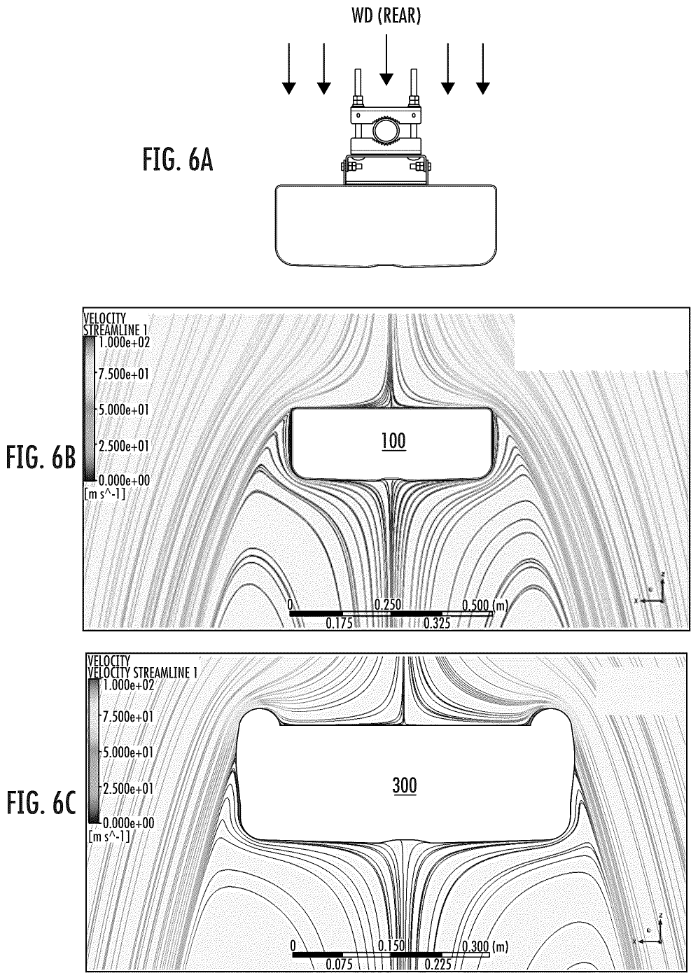

According to embodiments of the present invention, the presence of one or both examples of protuberances 210, 310 on the radome 101 can reduce the frontal and rear wind load experienced by the antenna 200, 300 compared to a similar “baseline” antenna 100 (i.e., FIGS. 1A-1B) that lacks the protuberances 210, 310 extending outwardly from the corners of the rear surface 103 and/or side surfaces 104, 106 of the radome 101. For example, FIGS. 5A-5C and FIGS. 6A-6C illustrate wind loading on an antenna 300 having both rear and side protuberances 210, 310 (i.e., FIG. 5C and FIG. 6C) as described herein compared to a baseline antenna 100 (i.e., FIG. 5B and FIG. 6B). FIGS. 5A-5C illustrate frontal wind loading (i.e., the wind load applied normal to the front surface 102 of the antenna 300) and FIGS. 6A-6C illustrate rear wind loading (i.e., the wind load applied normal to the rear surface 103 of the antenna 300). The figures show reduced wind load for the antenna 300 because the flow lines separate later in the flow direction compared to antenna 100.

As further examples of features that may reduce wind loading, in some embodiments, elements that change shape under wind load (e.g., are deflected, compressed, stretched, etc.) may be included. These may be particularly useful if the shape changes differently based on the wind direction. It will be understood that any or all of the protuberances 210, 310 may be formed with the radome 101 during manufacture (either integrally or as separate components), or may be added to an existing radome 101. It will be understood that various of the design elements discussed herein may be combined in a single antenna.

FIG. 7A and FIG. 7B illustrate further examples of design elements provided on antennas 400, 500 that can reduce wind loading according to embodiments of the present invention. As shown in FIG. 7A, the side surface 406 of the radome 401 of the antenna 400 has a slight front-to-rear taper which provides an improved wind loading profile. The antenna 500 shown in FIG. 7B is similar to the antenna 400 but further includes elongate protuberances 510 extending outwardly from the corners of the rear surface 503 of the radome 501 (similar to the rear protuberances 210, 310 described above with respect to antennas 200, 300). As shown in FIG. 7B, in some embodiments, the protuberances 510 may be integrally formed with the radome 501. Table 1 provides exemplary wind load (WL) reduction percentage for antennas incorporating the different design elements described herein as tested in a wind tunnel.

TABLE 1

| | Wind Load (WL) Reduction % | | | |
|---|---|---|---|---|
| WL Direction | Antenna 400 | Antenna 300 | Antenna 200 | Antenna 500 |
| Frontal | ~−23% | ~−6% | ~−7% | ~−27% |
| Lateral | Close | Close | ~+25% | ~+6% |
| Rear | ~−5% | ~−5% | ~−35% | ~−44% |
| Max | ~−5% | ~−5% | ~−19% | ~−28% |

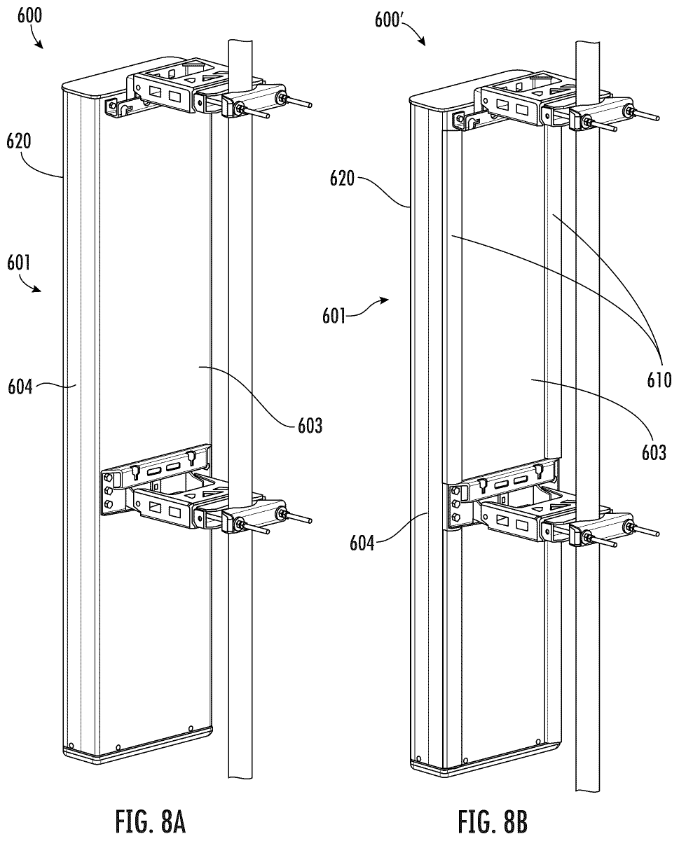

Referring now to FIGS. 8A-17B, additional examples of design elements that can reduce wind loading according to embodiments of the present invention are provided. Properties and/or features of the antennas and/or corresponding wind load reducing design elements (or airflow separation delaying features) may be as described above in reference to the antennas 200, 300, 400 shown in FIGS. 3-7B and duplicate discussion thereof may be omitted herein for the purposes of discussing FIGS. 8A-17B.

As discussed in further detail below, the design elements shown in FIGS. 8A-17B include exemplary modifications to the front corners of the radome of the antenna that may help to reduce wind loading on the antenna. In addition, one or more of the design features described above (e.g., side and/or rear protuberances 210, 310 extending from the side and/or rear surfaces 104, 106 of the radome 101) may also be incorporated into the antenna assemblies to further help reduce wind loading on the antenna. For example, FIG. 8A illustrates an antenna assembly 600 that includes design modifications 620 to the front corners of the radome 601 according to embodiments of the present invention (and described in further detail below) and FIG. 8B illustrates a similar antenna assembly 600′ with the addition of elongate protuberances 610 extending outwardly from the corners of the rear surface 603 of the radome 601 according to further embodiments of the present invention.

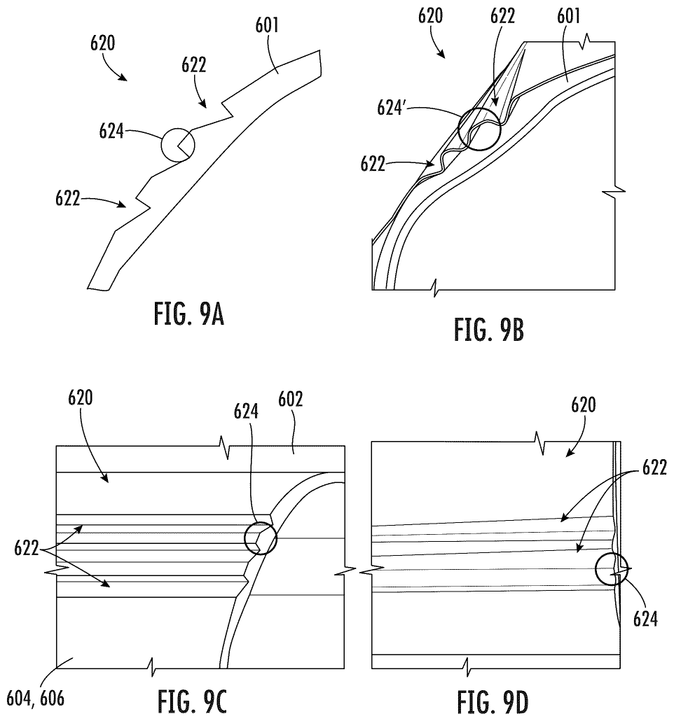

FIGS. 9A-9D illustrate an exemplary design feature 620 according to embodiments of the present invention that may be made to the radome 601 that may help reduce wind loading on the antenna assembly 600. As shown in FIGS. 9A-9D, in some embodiments, the design feature 620 comprises a plurality of recesses 622 formed in the front corners of the radome 601. It is desirable that the formation of the plurality of triangular recesses 622 results in a plurality of sharp edges or teeth 624 which allow for the highest reduction in wind loading on the antenna assembly 600.

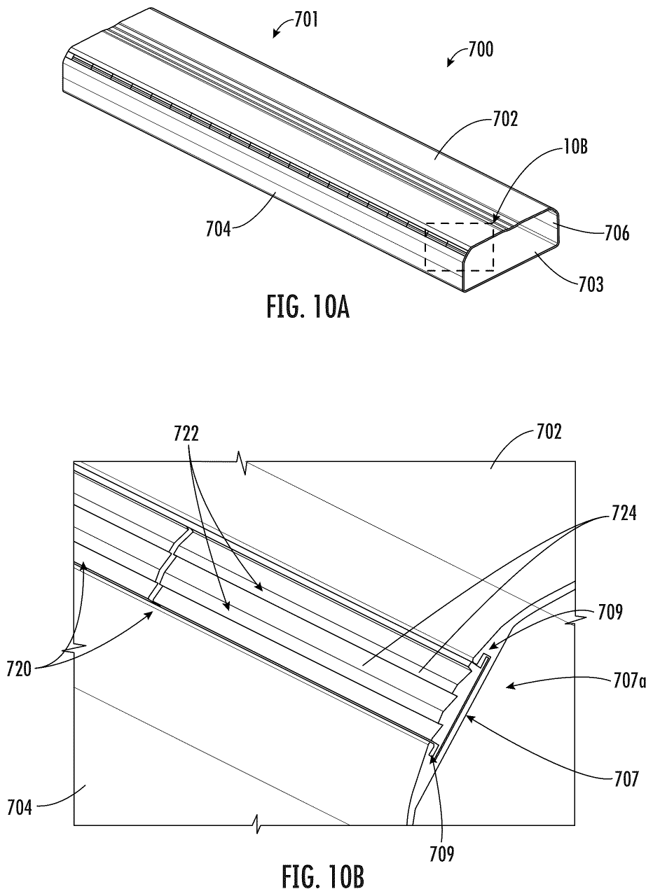

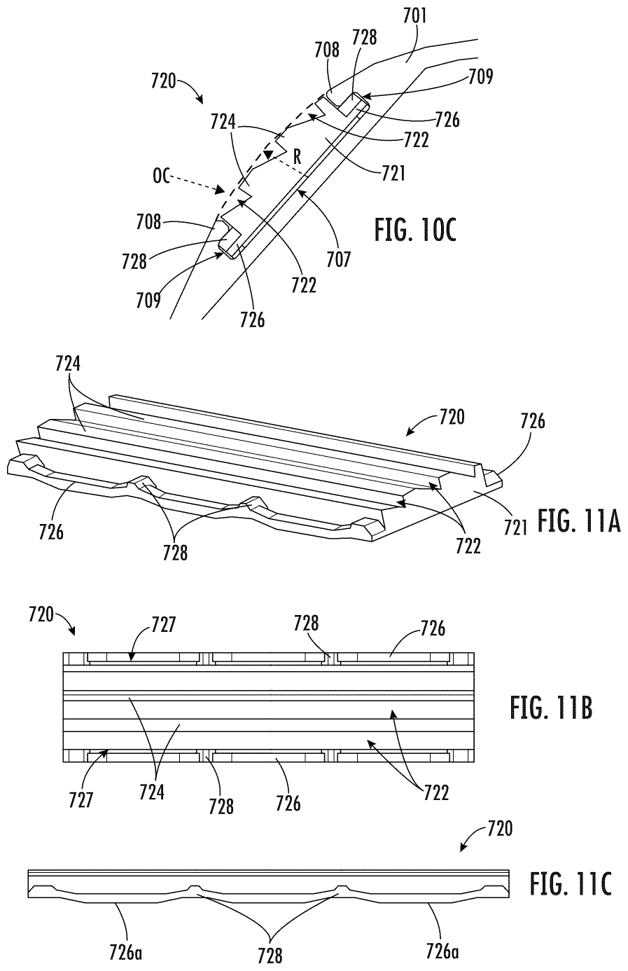

In some embodiments, the sharp edges 624 do not extend outwardly beyond a radius R of the outer curve OC defined by the front and side surfaces 102, 104, 106 of the radome 101 (see, e.g., FIG. 10C). However, in general, fiberglass radomes are formed by pultrusion, and the pultrusion process is unable to form the sharp (and some non-uniform) edges 624 needed to provide the desired reduction in wind loading. For example, the desired design features 620 illustrated in FIG. 9A and FIG. 9C show the plurality of recesses 622 forming sharp edges 624 on the front corner of the radome 601. However, the photographs of the exemplary radomes 601 shown in FIG. 9B and FIG. 9D illustrate that, during the pultrusion process, formation of the recesses 622 creates rounded (i.e., non-sharp) edges 624′. To overcome this issue, according to embodiments of the present invention, one or more inserts 720 comprising the desired sharp edges 724 may be formed separately via injection molding and installed on the pultruded radome 701 (see, e.g., FIGS. 10A-16B). Tables 2-5 provide exemplary wind load (WL) data for antennas incorporating the design feature 620 alone, and in combination with, other design features described herein (i.e., protuberances 210, 310) as tested in a wind tunnel.

TABLE 2

| | | Design Feature 620 | |
|---|---|---|---|
| | | Drag Force | Resultant Force |
| Wind Load | Frontal | 668 | 670 |
| Force | Lateral | 270 | 286 |
| | Rear | 1100 | 1100 |
| | Max | 1264 | 1278 |
| Percent to | Frontal | −25% | −25% |
| Baseline | Lateral | −6% | −5% |
| | Rear | −6% | −6% |
| | Max | −7% | −7% |

TABLE 3

| | | Design Feature 620 + 310 | |
|---|---|---|---|
| | | Drag Force | Resultant Force |
| Wind Load | Frontal | 825 | 826 |
| Force | Lateral | 329 | 363 |
| | Rear | 1096 | 1097 |
| | Max | 1311 | 1314 |
| Percent to | Frontal | −7% | −7% |
| Baseline | Lateral | 15% | 20% |
| | Rear | −7% | −6% |
| | Max | −3% | −4% |

TABLE 4

| | | Design Feature 620 + 210 | |
|---|---|---|---|
| | | Drag Force | Resultant Force |
| Wind Load | Frontal | 627 | 628 |
| Force | Lateral | 314 | 327 |
| | Rear | 637 | 637 |
| | Max | 960 | 1074 |
| Percent to | Frontal | −29% | −29% |
| Baseline | Lateral | 10% | 8% |
| | Rear | −46% | −46% |
| | Max | −29% | −22% |

TABLE 5

| | | Design Feature 620 + 210 + 310 | |
|---|---|---|---|
| | | Drag Force | Resultant Force |
| Wind Load | Frontal | 796 | 797 |
| Force | Lateral | 395 | 423 |
| | Rear | 655 | 660 |
| | Max | 1012 | 1107 |
| Percent to | Frontal | −10% | −10% |
| Baseline | Lateral | 38% | 40% |
| | Rear | −44% | −44% |
| | Max | −25% | −19% |

A radome assembly 700 according to embodiments or the present invention which includes one or more inserts 720 that are configured to reduce wind loading on the assembly 700 is illustrated in FIGS. 10A-10C. As shown in FIGS. 10A-10C, the front corners of the radome 701 (i.e., the corners between the front surface 702 and the side surfaces 704, 706 of the radome 701) each have a cavity or recess 707 formed therein. The cavity 707 is sized and configured to receive and secure one or more inserts 720 therein. The cavity 707 can be pultruded along with the remainder of the radome 701.

An exemplary insert 720 is illustrated in FIGS. 11A-11C. In some embodiments, the insert 720 is formed from a polymeric (e.g., plastic) material. As shown in FIGS. 11A-11C, the insert 720 has a main body 721 that comprises a plurality of recesses formed 722 therein (see also, e.g., FIGS. 10B-10C). An outer surface of the main body 721 of the insert 720 comprises a plurality of sharp edges 724 residing between each triangular recess 722. In some embodiments, one or more compressible sections 726 are coupled to opposing sides of the main body 721 of the insert 720. In some embodiments, the one or more compressible sections 726 are coupled to the main body 721 via protrusions 728 which act as a bridge between the compressible sections 726 and the main body 721 of the insert 720. As shown in FIGS. 11A-11C, the compressible sections 726 extend along a length of the main body 721. As shown in FIG. 11B, in some embodiments, gaps 727 may reside between the compressible sections 726 and the main body 721 (except where the protrusions 728 couple the compressible sections 726 to the main body 721), thereby allowing the compressible sections 726 to move (e.g., flex or compress) relative to the main body 721 to help secure the insert 720 within the cavity 707 of the radome 701 (as described in further detail below). In some embodiments, the protrusions 728 are more rigid than the compressible sections 726, thereby providing additional structural support to the insert 720, while also helping to support the compressible sections 726 (e.g., when compressed within channels 709 of the cavity 707). In some embodiments, each compressible section 726 may have a slightly arcuate profile between each protrusion 728 (see, e.g., FIG. 11A and FIG. 11C).

Referring back to FIG. 10B and FIG. 10C, the one or more inserts 720 are configured to be received within the cavity 707 of the radome 701. For example, in some embodiments, a single insert 720 may be inserted into the cavity 707. In other embodiments, two or more inserts 720 may be inserted into the cavity 707. In some embodiments, the insert(s) 720 are configured to be slid through an opening 707a located at one or both ends of the cavity 707. In some embodiments, the opening of the cavity 707 in the radome 701 may comprise a pair of opposing shoulders 708 that extend inwardly over the cavity 707. The shoulders 708 define channels 709 within the cavity 707 which are configured to receive the compressible sections 726 of the insert 720. The shoulders 708 help to hold and secure the insert(s) 720 within the cavity 707, thereby securing the insert(s) 720 to the radome 701. In some embodiments, the one or more protrusions 728 and/or the compressible sections 726 help provide a tight (e.g., interference) fit between the insert 720 and the radome 701 within the channels 709. As noted above, these types of sharp edges 724 cannot easily be formed via a pultrusion or extrusion process, but may be formed via an injection molding process.

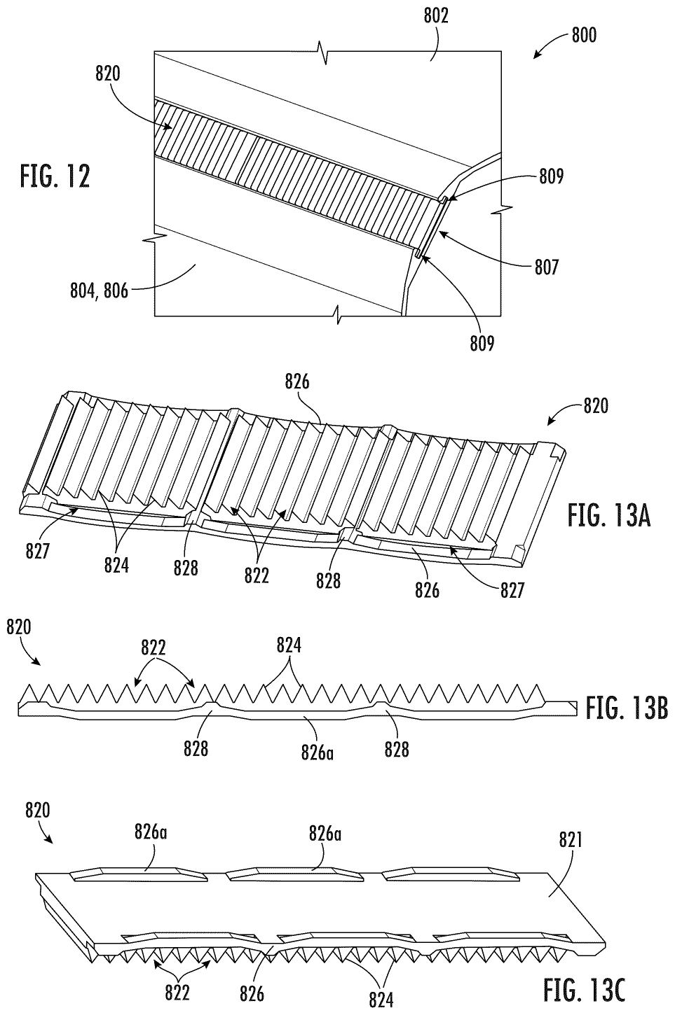

Referring to FIG. 12 and FIGS. 13A-13C, an alternative radome assembly 800 and corresponding wind load reducing design feature (i.e., insert(s) 820) according to embodiments of the present invention are illustrated. Properties and/or features of the radome assembly 800 and inserts 820 may be as described above in reference to the radome assembly 700 and corresponding inserts 720 shown in FIGS. 10A-10C and FIGS. 11A-11C and duplicate discussion thereof may be omitted herein for the purposes of discussing FIG. 12 and FIGS. 13A-13C.

The radome assembly 800 includes one or more inserts 820 that are configured to reduce wind loading on the assembly 800. Similar to the radome assembly 700 and insert 720 described herein, as shown in FIG. 12 and FIGS. 13A-13C, the front corners of the radome 801 of assembly 800 include a cavity 807 having a pair of channels 809 defined therein. The cavity 807 is configured to receive one or more inserts 820 and the channels 809 are configured to receive compressible sections 826 of the respective inserts 820, thereby securing the inserts 820 to the radome 801. The insert 820 differs from the insert 720 described herein in the sharp edges 824 extending from the main body 821 of the insert 820. As shown in FIGS. 13A-13C, the sharp edges 824 of insert 820 are formed as “teeth” (e.g., have a defined triangular shape). The sharp edges 824 are separated by recesses 822 and extend parallel to each other (e.g., “ribs”) along a width of the main body 821 of the insert 820 (i.e., in cross-section). Similar to the insert(s) 720 described herein, in some embodiments, each compressible sections 826 is coupled to the main body 821 of the insert 820 via one or more protrusions 828 which act as a bridge to define gaps 827 between the compressible sections 826 and the main body 821 of the insert 820. In addition, in some embodiments, the compressible sections 826 may have a slightly arcuate profile (see, e.g., FIG. 13B). The one or more protrusions 828 and/or compressible sections 826 help to provide a tight (e.g., interference) fit between the insert 820 and the radome 801 within the channels 809. Similar to the sharp edges 724 of insert 720, the sharp edges 824 of insert 820 cannot easily be formed via a pultrusion or extrusion process (or at all), but may be formed via an injection molding process.

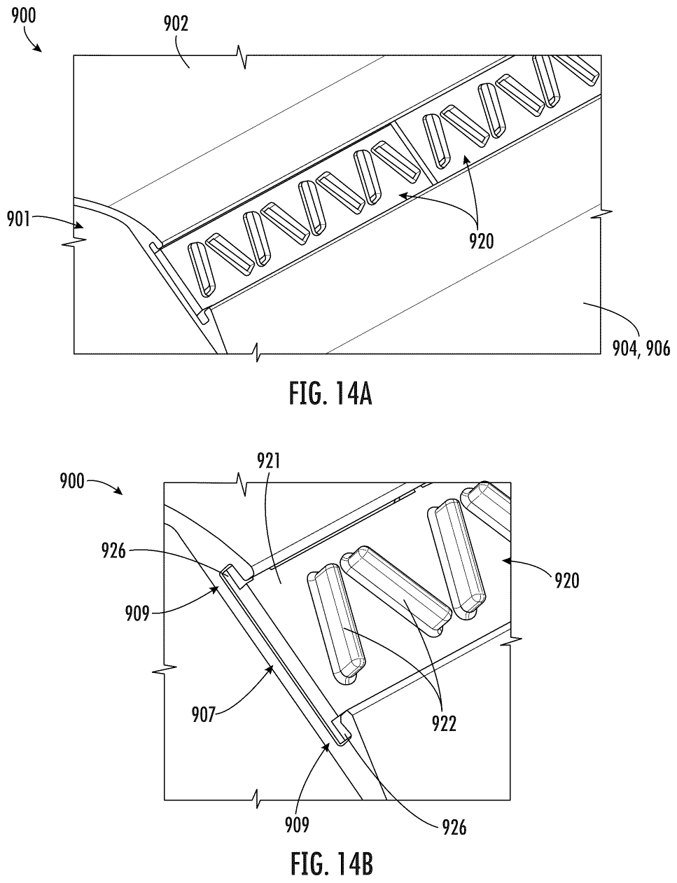

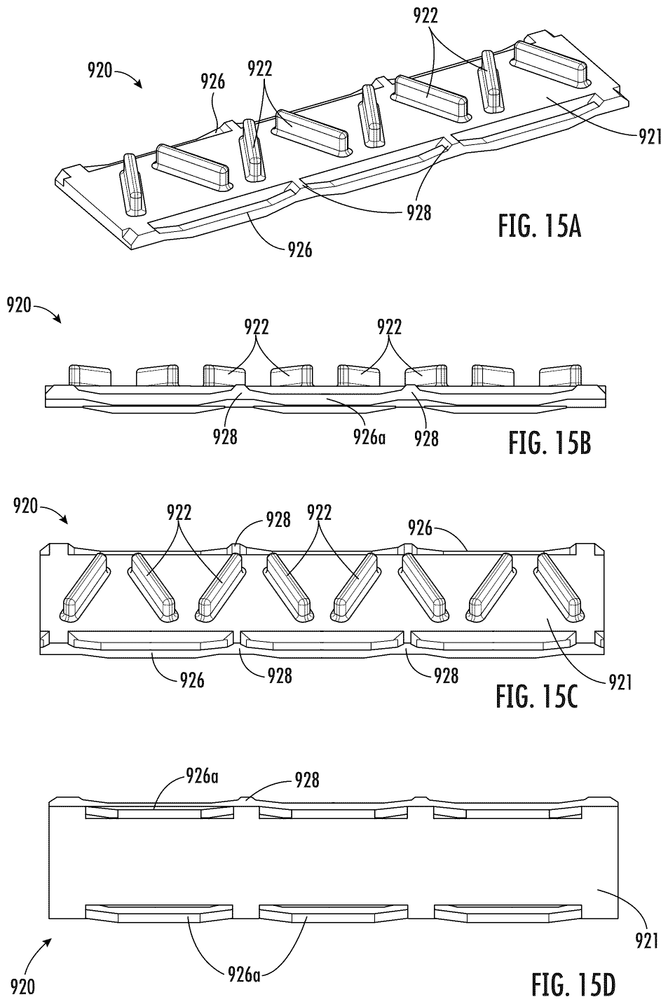

Referring to FIGS. 14A-14B and FIGS. 15A-15D, another radome assembly 900 having wind load reducing design elements (i.e., inserts 920) according to embodiments of the present invention are illustrated. Properties and/or features of the radome assembly 900 and corresponding inserts 920 be as described above in reference to the radome assemblies 700, 800 and corresponding inserts 720, 820 shown in FIGS. 10A-13C and duplicate discussion thereof may be omitted herein for the purposes of discussing FIG. 14A-14B and FIGS. 15A-15D.

The radome assembly 900 includes one or more inserts 920 that are configured to reduce wind loading on the assembly 900. Similar to the radome assemblies 700, 800 and corresponding inserts 720, 820 described herein, as shown in FIGS. 14A-14B, the front corners of the radome 901 of the assembly 900 include a cavity 907 having a pair of channels 909 defined therein. The cavity 907 is configured to receive one or more inserts 920. The channels 909 are configured to receive the compressible sections 926 extending outwardly from the main body 921 of the respective inserts 920, thereby holding and securing the inserts 920 to the radome 901.

As shown in FIGS. 14A-14B and FIGS. 15A-15D, the inserts 920 differ from the other inserts 720, 820 described herein, in that the inserts 920 comprise one or more pairs of protruding elements or ribs 922 extending outwardly from the main body 921. In some embodiments, each rib 922 is spaced apart from each other and extends along the width of the main body 921 at an angle. For example, as shown in FIGS. 14A-14B, FIG. 15A and FIG. 15C, each pair of ribs 922 may be reside in a substantially “V-shape” on the main body 921. Similar to the insert(s) 720, 820 described herein, in some embodiments, each compressible section 926 coupled to opposing sides of the main body 921 of the insert 920 via one or more protrusions 928. In addition, in some embodiments, the compressible sections 926 may have a slightly arcuate profile 926a (see, e.g., FIG. 15A-15B). The one or more protrusions 928 and/or compressible sections 926 help to provide a tight (e.g., interference) fit between the insert 920 and the radome 901 within the channels 909. It is noted that the protruding elements or ribs cannot be easily formed via a pultrusion or extrusion process, but are feasible via an injection molding process.

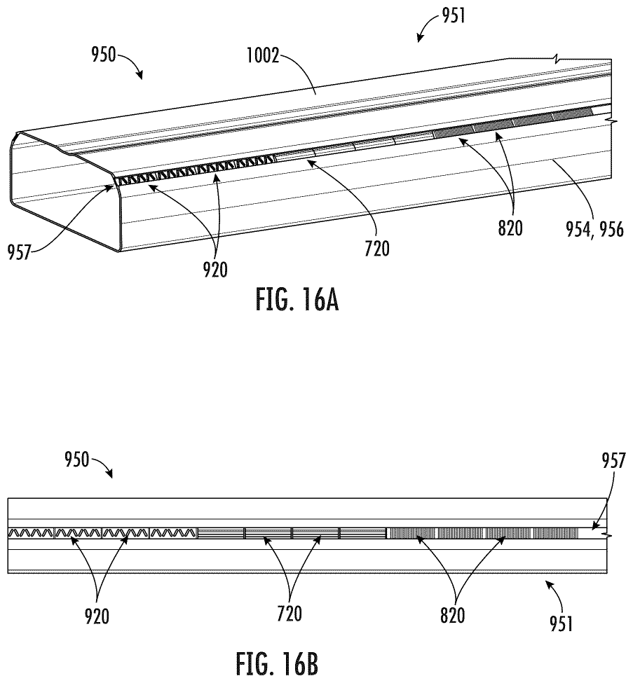

According to embodiments of the present invention, one or more different types of the wind load reducing design elements described herein may be combined in the same radome assembly to integrate the different functions of the respective design elements. For example, as shown in FIGS. 16A-16B, in some embodiments, a radome assembly 950 may include one or more of each insert 720, 820, 920 described herein.

Referring now to FIGS. 17-25, alternative configurations for wind load reducing design elements that may be used to modify the “baseline” antenna assembly 100 (see, e.g., FIGS. 1A-1B) according to embodiments of the present invention are illustrated. Properties and/or features of the wind load reducing design elements may be as described above and duplicate discussion thereof may be omitted herein for the purposes of discussing FIGS. 17-25.

Referring to FIG. 17, an antenna assembly 1000 according to embodiments of the present invention is illustrated in which the wind load reducing design element comprises a pair of plate members 1020. As shown in FIG. 17, each plate member 1020 is coupled to a respective side surface 104, 106 of the radome 101. In some embodiments, the plate members 1020 may extend rearwardly a distance past the rear surface 103 of the radome 101. In some embodiments, the plate members 1120 may engage with an antenna mounting bracket 130. The plate members 1020 may be positioned to block at least some of the wind load from traveling between the rear surface 103 of the radome 101 and the antenna bracket mount 130, thereby reducing wind loading on the assembly 1000.

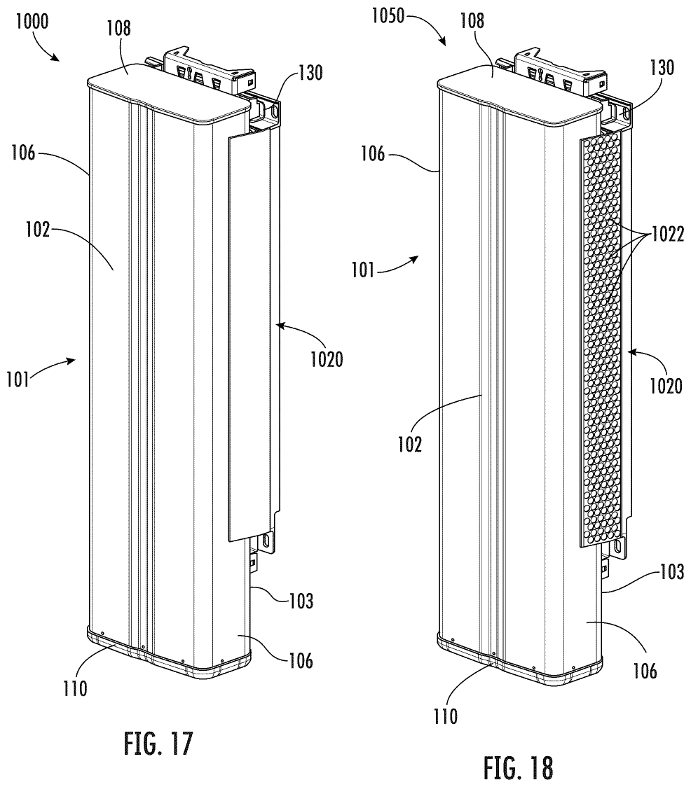

FIG. 18 illustrates another antenna assembly 1050 according to embodiments of the present invention. As shown in FIG. 18, the antenna assembly 1050 includes a similar wind load reducing design as antenna assembly 1000 shown in FIG. 17 (i.e., a pair of plate members 1020), except each plate member 1020 comprises a plurality of arcuate protuberances 1022 extending outwardly therefrom.

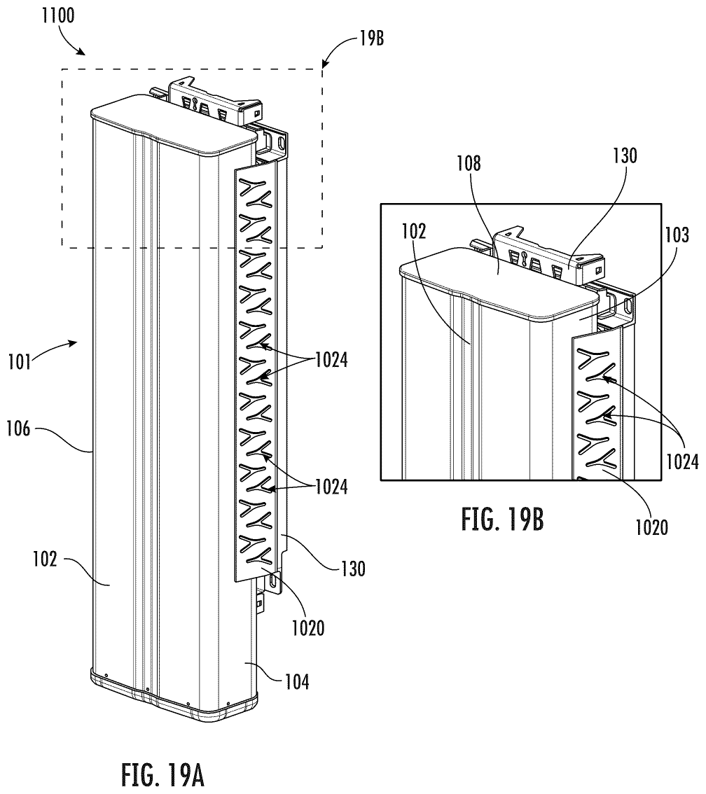

According to embodiments of the present invention, the antenna assembly 1100 illustrated in FIGS. 19A-19B also includes a wind load reducing design element that includes a pair of plates 1020. As shown in FIGS. 19A-19B, each plate 1020 comprises a plurality of protruding elements or ribs 1024. In some embodiments, the protruding elements 1024 are Y-shaped and arranged on the plates 1020 such that adjacent protruding elements 1024 are positioned to face in opposing directions (i.e., the protruding elements 1024 alternate directions).

In some embodiments, the plates 1020 incorporated into the antenna assemblies 1000, 1050, 1100 extend along the length of the radome 101 which distance can vary depending on the wind load reduction needed. For example, as shown in FIGS. 17, 18, and 19A, in some embodiments, the length of the plates 1020 may correspond approximately to the length of the antenna mounting bracket 130.

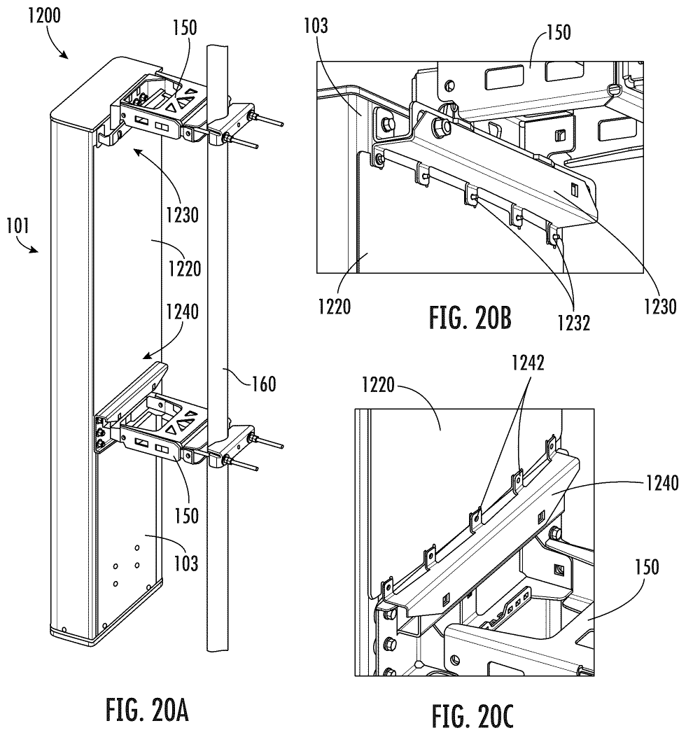

Referring to FIGS. 20A-20C, an antenna assembly 1200 according to embodiments of the present invention is illustrated in which the wind load reducing design element comprises a plate member 1220, a first (e.g., upper) bracket member 1230, and a second (e.g., lower) bracket member 1240. The plate member 1220 is sized and configured to be secured against the rear surface 103 of the radome 101. The first and second bracket members 1230, 1240 are configured to be secured to respective antenna mounting members 150. In some embodiments, the first and second bracket members 1230, 1240 each comprise a plurality of tabs 1232, 1242 extending outwardly therefrom. In some embodiments, the plurality of tabs 1232, 1242 are configured secure the plate member 1220 against the rear surface 103 of the radome 101. In some embodiments, fasteners may be inserted through the tabs 1232, 1242 to further secure the plate member 1220 to the radome 101. Table 6 provides exemplary wind load data for antenna assembly 1200 as tested in a wind tunnel.

TABLE 6

| | | Antenna Assembly 1200 | |
|---|---|---|---|
| | | Drag Force | Resultant Force |
| Wind Load | Frontal | 895 | 899 |
| Force | Lateral | 280 | 284 |
| | Rear | 1039 | 1043 |
| | Max | 1237 | 1246 |
| Percent to | Frontal | 1% | 1% |
| Baseline | Lateral | −2% | −6% |
| | Rear | −11% | −11% |
| | Max | −9% | −9% |

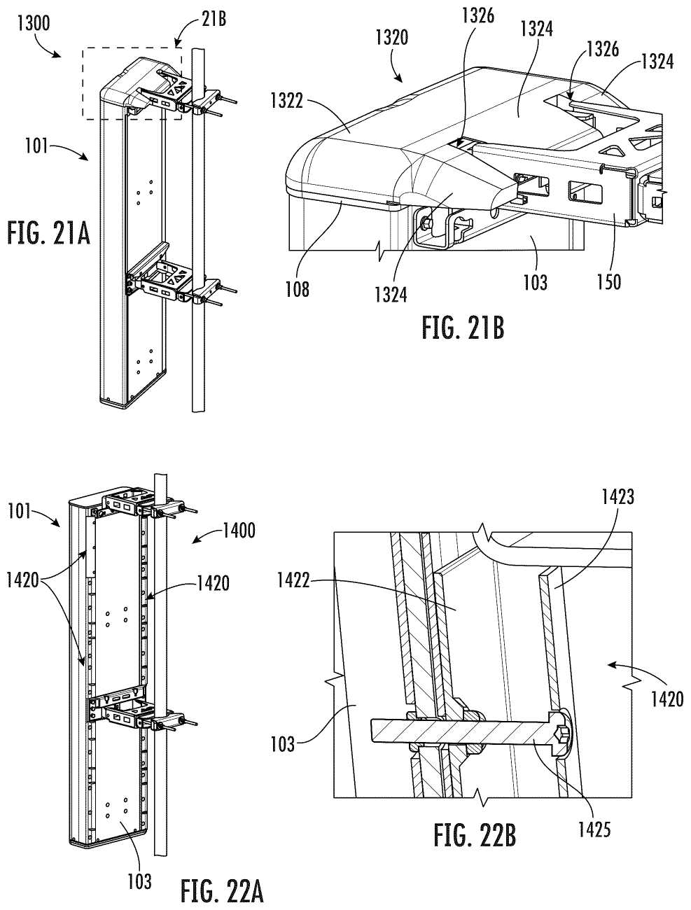

Referring to FIGS. 21A-21B, an antenna assembly 1300 according to embodiments of the present invention is illustrated in which the wind load reducing design element comprises a top hood 1320. The top hood 1320 may be used in place of or secured to the top end cap 108 of the radome 101. As shown in FIG. 21B, the top hood 1320 has a main body 1322 with a plurality of arms 1324 that extend rearwardly therefrom. In some embodiments, the arms 1324 may extend past the rear surface 103 of the radome 101. Adjacent arms 1324 define a recess 1326 therebetween, each recess 1326 being configured to receive at least a portion of an upper antenna mount 150 (see, e.g., FIG. 21B). Table 7 provides exemplary wind load data for antenna assembly 1300 as tested in a wind tunnel.

TABLE 7

| | | Antenna Assembly 1300 | |
|---|---|---|---|
| | | Drag Force | Resultant Force |
| Wind Load | Frontal | 817 | 822 |
| Force | Lateral | 277 | 301 |
| | Rear | 1113 | 1114 |
| | Max | 1341 | 1380 |
| Percent to | Frontal | −8% | −8% |
| Baseline | Lateral | −4% | −1% |
| | Rear | −5% | −5% |
| | Max | −1% | 1% |

Referring to FIGS. 22A-22B, an antenna assembly 1400 according to embodiments of the present invention is illustrated in which the wind load reducing design element comprises a plurality of rear elongate protuberance members 1420 secured to the rear surface 103 of the radome 101. In some embodiments, the rear protuberance members 1420 are similar to other rearwardly extending protuberances 210, 510, 610 described herein (see, e.g., FIGS. 3, 4, 7B, and 8B). As shown in FIG. 22B, in some embodiments, each rear protuberance member 1420 may comprise a planar surface 1422 configured to contact the rear surface 103 of the radome 101 and an arcuate surface 1423 that extends outwardly from the planar surface 1422 (i.e., outwardly from the rear surface 103 of the radome 101). As shown in FIG. 22A, in some embodiments, two or more rear protuberances members 1420 may be secured adjacent to opposing edges (i.e., corners) of the rear surface 103 of the radome 101. In some embodiments, the rear protuberance members 1420 may be positioned to extend substantially the entire length of the radome 101. As shown in FIG. 22B, in some embodiments, each rear protuberance member 1420 may be secured to the rear surface 103 of the radome 101 via one or more fasteners 1425 extending therethrough. Table 8 provides exemplary wind load data for antenna assembly 1400 as tested in a wind tunnel.

TABLE 8

| | | Antenna Assembly 1400 | |
|---|---|---|---|
| | | Drag Force | Resultant Force |
| Wind Load | Frontal | 816 | 816 |
| Force | Lateral | 382 | 471 |
| | Rear | 749 | 751 |
| | Max | 1090 | 1171 |
| Percent to | Frontal | −8% | −8% |
| Baseline | Lateral | 33% | 55% |
| | Rear | −36% | −36% |
| | Max | −19% | −14% |

Referring to FIGS. 23A-23B, an antenna assembly 1500 according to embodiments of the present invention is illustrated in which the wind load reducing design element comprises a plurality of side elongate protuberance members 1430. As shown in FIGS. 23A-23B, in some embodiments, the plurality of side protuberance members 1430 are in addition to the plurality of rear protuberance members 1420 described herein. In some embodiments, the side protuberance members 1430 are similar to the protuberances 310 described herein (see, e.g., FIG. 4). As shown in FIG. 23A, in some embodiments, two or more side protuberances members 1430 may be secured to the side surfaces 104, 106 of the radome 101. In some embodiments, the side protuberance members 1430 may be positioned to extend substantially the entire length of the radome 101. Table 9 provides exemplary wind load data for antenna assembly 1500 as tested in a wind tunnel.

TABLE 9

| | | Antenna Assembly 1500 | |
|---|---|---|---|
| | | Drag Force | Resultant Force |
| Wind Load | Frontal | 782 | 783 |
| Force | Lateral | 314 | 351 |
| | Rear | 736 | 737 |
| | Max | 989 | 1396 |
| Percent to | Frontal | −12% | −12% |
| Baseline | Lateral | 9% | 16% |
| | Rear | −37% | −37% |
| | Max | −27% | 2% |

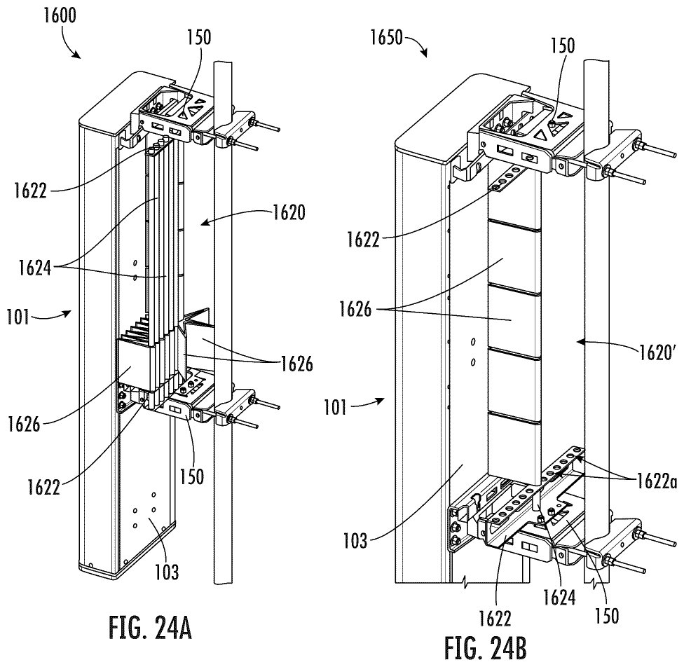

Referring to FIGS. 24A-24B, antenna assemblies 1600, 1650 according to embodiments of the present invention are illustrated in which the wind load reducing design element 1620 comprises one or more rotator blades 1626. As shown in FIGS. 24A-24B, first and second brackets 1622 are configured to be secured to respective antenna mount brackets 150. Each of the first and second brackets 1622 include a plurality of apertures 1622a. Each aperture 1622a is configured to receive and secure a respective pipe or other mounting member 1624 to the first and second brackets 1622. Each pipe 1624 has one or more rotator blades 1626 rotatably coupled thereto. For example, as shown in FIG. 24A, in some embodiments, multiple pipes 1624 may be received within the apertures 1622a, each pipe 1624 having a rotator blade 1626 coupled thereto. In other embodiments, for example, as shown in FIG. 24B, a single pipe 1624 has multiple rotator blades 1626 coupled thereto. The rotator blades 1626 are configured to be adjusted (i.e., rotated relative to the respective pipe 1624) to provide wind load reduction in the direction needed. Table 10 provides exemplary wind load data for antenna assembly 1600 as tested in a wind tunnel.

TABLE 10

| | | Antenna Assembly 1600 | |
|---|---|---|---|
| | | Drag Force | Resultant Force |
| Wind Load | Frontal | 946 | 953 |
| Force | Lateral | 309 | 536 |
| | Rear | 1187 | 1188 |
| | Max | 1412 | 1447 |
| Percent to | Frontal | 7% | 7% |
| Baseline | Lateral | 8% | 77% |
| | Rear | 1% | 1% |
| | Max | 4% | 6% |

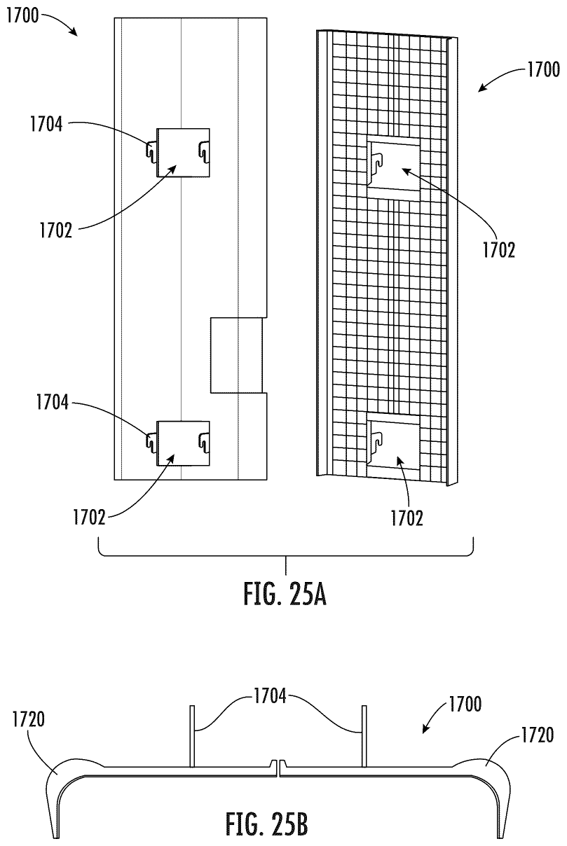

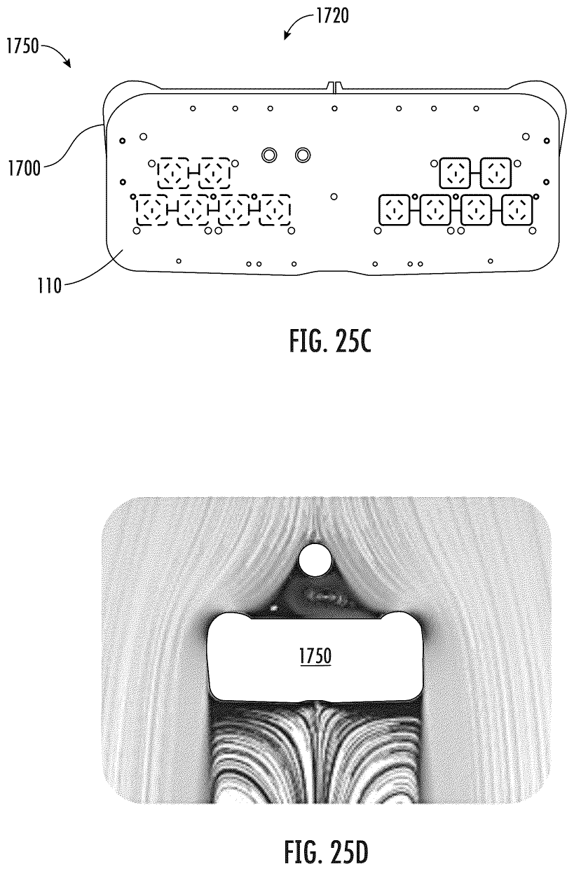

Referring to FIGS. 25A-25D, a radome shield 1700 according to embodiments of the present invention is illustrated. The radome shield 1700 is configured to provide wind load reduction on an antenna assembly 1750 while also helping to reduce passive intermodulation (PIM). The radome shield 1700 is sized and configured to fit on the rear surface 103 of the radome 101. As shown in FIG. 25A, in some embodiments, the radome shield 1700 has one or more openings 1702 such that the radome 101 (i.e., antenna) may be secured to an antenna mount bracket. In some embodiments, the radome shield 1700 may also include fasteners 1704 (e.g., latches) to help secure the radome shield 1700 to the corresponding antenna mount bracket(s). Thus, in some embodiments, the radome shield 1700 may be used to retrofit existing radomes 101 to add wind load reducing design elements such as those described herein.

For example, as shown in FIG. 25B, in some embodiments, the radome shield 1700 includes one or more of the wind load reducing design elements described herein (e.g., protuberances 1720). As shown in FIGS. 25B-25C, the protuberances 1720 are shaped similar to the other rearwardly extending protuberances 210, 510, 610, 1420 described herein (see, e.g., FIGS. 3, 4, 7B, 8B, 22A and 23B). In some embodiments, the radome shield 1700 is formed from a polymeric material which allows the edges of the radome shield 1700 to engage the rear corners of the radome 101, thereby securing the radome shield 1700 to the radome 101 (see, e.g., FIG. 25C). FIG. 25D illustrates exemplary rear wind loading (i.e., the wind load applied normal to the rear surface of the antenna) on an antenna assembly 1750 having the radome shield 1700 installed thereon. In some embodiments, the radome shield 1700 may reduce wind load on the antenna assembly 1750 between 10 to 20 percent. See, e.g., Table 11 (below).

TABLE 11
Wind Load (WL) Force Comparison

| | WL without Shield | WL with Shield | WL Reduction |
|---|---|---|---|
| Maximum | 755N | 641N | −15% ↓ |

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

What is claimed is:

1. A reduced wind load antenna, the antenna comprising:
a radome having front, rear, and side surfaces;
upper and lower end caps attached to upper and lower ends of the radome to define an internal cavity,
radiating elements positioned within the internal cavity and configured to transmit and receive radio frequency (RF) signals; and
at least two airflow separation delaying features, each airflow separation delaying feature coupled to and extending outwardly from a position at or adjacent to a corner of the rear surface of the radome, whereby the at least two airflow separation delaying features reduce the wind load applied normal to the front surface of the antenna and/or the wind load applied normal to the rear surface of the antenna.

2. The antenna defined in claim 1, wherein each airflow separation delaying feature extends essentially the length of the rear surface of the radome.

3. The antenna defined in claim 1, wherein the side surfaces of the radome are slightly tapered from the front surface to the rear surface.

4. The antenna defined in claim 1, further comprising at least four airflow separation delaying features, at least two airflow separation delaying features residing on the side surfaces of the radome adjacent to the at least two airflow separation delaying features extending outwardly from the rear surface of the radome.

5. The antenna defined in claim 1, wherein each of the airflow separation delaying features is an elongate protuberance.

6. The antenna defined in claim 4, wherein the at least two airflow separation delaying features extend essentially the entire length of the side surfaces of the radome.

7. The antenna defined in claim 1, wherein the at least two airflow separation delaying features extend longitudinally over 10 to 25 percent of a length of the radome.

8. The antenna defined in claim 1, wherein the at least two airflow separation delaying features extend longitudinally over 50 to 100 percent of a length of the radome.

9. The antenna defined in claim 1, further comprising a shield configured to be secured to the rear surface of the radome, wherein the at least two airflow separation delaying features reside on the shield.

10. The antenna defined in claim 9, wherein the shield is formed from a polymeric material.

11. A reduced wind load antenna, the antenna comprising:
a radome having front, rear, and side surfaces, wherein the radome comprises a cavity formed between the front surface and at least one of the side surfaces; and
at least one wind load reduction insert configured to fit within the cavity in the radome, the at least one wind load reduction insert having a main body comprising a plurality of recesses formed therein and a plurality of sharp edges residing between each recess.

12. The antenna defined in claim 11, wherein the at least one wind load reduction insert further comprises one or more compressible sections coupled to opposing sides of the main body, the compressible sections configured to be received by respective channels formed in the cavity to secure the wind load reduction insert within the cavity.

13. The antenna defined in claim 12, wherein the compressible sections are coupled to the opposing sides of the main body via a plurality of protrusions which define gaps between the compressible sections and the main body of the insert.

14. The antenna defined in claim 11, wherein the recesses of the wind load reduction insert have a triangular shape.

15. The antenna defined in claim 11, wherein the sharp edges extend parallel to each other along a width of the main body of the wind load reduction insert.

16. The antenna defined in claim 11, wherein the sharp edges do not extend beyond a radius of the outer curve between the front and side surfaces of the radome.

17. A reduced wind load antenna, the antenna comprising:
a radome having front, rear, and side surfaces, wherein the radome comprises a cavity formed between the front surface and at least one of the side surfaces; and
at least one wind load reduction insert configured to fit within the cavity in the radome, the at least one wind load reduction insert having a main body comprising one or more pairs of protruding ribs extending outwardly from the main body, each rib being spaced apart from each other and extending along a width of the main body at an oblique angle.

18. The antenna defined in claim 17, wherein each pair of ribs reside in a V-shape on the main body.

19. The antenna defined in claim 17, wherein the at least one wind load reduction insert further comprises one or more compressible sections coupled to opposing sides of the main body, the compressible sections configured to be received by respective channels formed in the cavity to secure the wind load reduction insert within the cavity.

19. The antenna defined in claim 19, wherein the compressible sections are coupled to the opposing sides of the main body via a plurality of protrusions which define gaps between the compressible sections and the main body of the insert.
